(19) United States
(12) Patent Application Publication
(10) Pub. No.: US 2025/0360453 A1
(43) Pub. Date: Nov. 27, 2025

(54) APPARATUS AND METHOD FOR EXTRACTING CO2 FROM AIR

(71) Applicant: Purem GmbH, Neunkirchen (DE)

(72) Inventors: Thomas Wolf, Esslingen (DE); Heike Többen, Uhingen (DE)

(21) Appl. No.: 19/217,434

(22) Filed: May 23, 2025

(30) Foreign Application Priority Data
May 24, 2024 (DE) 10 2024 114 586.2
Jul. 18, 2024 (DE) 10 2024 120 258.0

(51) Int. Cl. B01D 53/04

(52) U.S. Cl. CPC B01D 53/0462; B01D 2253/108; B01D 2253/20; B01D 2253/25; B01D 2257/504

(57) ABSTRACT

An apparatus for extracting CO₂ from air includes at least one extraction reactor through which CO₂-containing air is able to flow in an adsorption mode and which has an adsorption surface. A heating assembly is provided for heating the at least one extraction reactor at least in the region of its adsorption surface to a temperature above an extracted gas desorption temperature in a heating mode. At least one extracted gas store is provided for storing CO₂ desorbed from the at least one extraction reactor in a desorption mode.

### CROSS-REFERENCE TO RELATED APPLICATIONS

This application claims priority of German patent application nos. 10 2024 114 586.2, filed May 24, 2024, and 10 2024 120 258.0, filed Jul. 18, 2024, the entire contents of which are incorporated herein by reference.

### TECHNICAL FIELD

The present disclosure relates to an apparatus and a method for extracting CO₂ from air.

### BACKGROUND

In order to prevent an excessive, climate-change-promoting increase in the level of CO₂ in the earth's atmosphere, extensive measures are being taken to reduce CO₂ emissions. However, these measures are not able to contribute to lowering the already existing level of CO₂, that is, to retrieving from the earth's atmosphere the CO₂ that is already present in it. An example of a known way of achieving this is to generate natural stores of extracted gas through extensive measures for reforestation or measures for renaturation of moors.

### SUMMARY

It is an object of the present disclosure to provide an apparatus and a method for extracting CO₂ from air, via which the removal of CO₂ from air is achieved reliably and efficiently in a simple technical realization.

In a first aspect of the present disclosure, this object is achieved by an apparatus for extracting CO₂ from air, including:
at least one extraction reactor through which CO₂-containing air is able to flow in an adsorption mode and which has an adsorption surface,
a heating assembly for heating the at least one extraction reactor at least in the region of its adsorption surface to a temperature above an extracted gas desorption temperature in a heating mode,
at least one extracted gas store for storing CO₂ desorbed from the at least one extraction reactor in a desorption mode.

As a result of the alternating adsorption and desorption of CO₂ in one or more extraction reactors and the supply of the desorbed CO₂ as extracted gas to one or more extracted gas stores, CO₂ can be removed from the air, that is, in particular also the earth's atmosphere, in a clocked operation, stored and optionally further used in chemical processes or further used directly, for example as welding gas.

It should be noted that the present disclosure can be used particularly advantageously in the extraction of CO₂ (carbon dioxide) from the earth's atmosphere, that is, from air. However, the present disclosure can also be used in connection with other CO₂-containing gas mixtures. In this respect, air is to be regarded merely as an example or placeholder for such CO₂-containing gas mixtures. All aspects of the disclosure set out below can equally be used in apparatuses and methods via which CO₂ as extracted gas is extracted from CO₂-containing gas mixtures other than air.

Similarly, CO₂ as extracted gas is to be regarded only as an example or placeholder for any other gas which is present in a gas mixture and is to be extracted therefrom and which can be extracted from the gas mixture by adsorption and released again by subsequent desorption and conducted into an appropriate store. All aspects of the disclosure set out below can equally be used in apparatuses and methods via which extracted gases other than CO₂, for example water or steam, are extracted from air or other gas mixtures containing them.

In order to be able to make the process of adsorption and desorption efficient, it is proposed that the extraction reactor include at least one substrate having a multiplicity of flow-through cells or flow channels in a porous structure, and that the substrate be coated with an adsorption coating providing the adsorption surface. Such substrates are known, for example, from exhaust gas cleaning in internal combustion engines and are used, for example, in particulate filters or in catalytic converters. They can have a honeycombed or porous structure with a surface which is very large in relation to the volume used and around which the gas mixture containing a gas to be extracted can flow, thus allowing use of the surface for adsorption.

For the treatment of large volumes of air, it is proposed that at least one, preferably each, extraction reactor include an extraction unit having a plurality of parallel substrates through which air is able to flow and which are coated with an adsorption coating.

For example, the substrate may be made of, for example, monolithically formed SiC. Alternatively, the substrate may be made using:
cordierite, or
a metallic material, preferably a metal foam or metallic honeycomb structure, or
a ceramic material, preferably a ceramic foam or ceramic honeycomb structure.

For efficient adsorption of CO₂ as extracted gas, the adsorption coating may be made of materials such as zeolite or of an organometallic material, for example MOF CALF-20. Such materials or organometallic lattice structures form a coating which has high selectivity, that is, pronounced adsorption behavior, with respect to the medium to be adsorbed, that is, for example CO₂.

In order to be able to efficiently bring the temperature of such an extraction reactor to a temperature above the desorption temperature of, for example, CO₂ for the desorption mode, for example a temperature of higher than 50° C., preferably in the range from 100° C. to 150° C., the heating assembly may include a heating gas circuit with a heating gas conveying assembly for conveying heating gas through the at least one extraction reactor and a heating gas heating device for heating the heating gas to a temperature above the extracted gas desorption temperature. Conducting heating gas through the open-celled or porous structure of an extraction reactor ensures that the extraction reactor can be reliably brought to the necessary temperature throughout its adsorption surface.

For heating of the heating gas, the heating gas heating device may include at least one electrically energizable heating gas heater or/and at least one heating gas heat exchanger through which a heat transfer medium is able to flow. The use of such a heating gas heat exchanger through which a heat transfer medium is able to flow is particularly advantageous because the heat transfer medium can be heated using renewable energy, for example power generated by solar thermal energy, by geothermal energy or with a photovoltaic system.

Especially when loss of heating gas occurs in the heating mode, it is advantageous if the heating assembly includes at least one heating gas store for refeeding heating gas into the heating gas circuit.

In an embodiment, the heating gas is CO₂, that is, the same gas as the gas to be extracted. As a result, it is not necessary, in a desorption mode following the heating mode and in the subsequent storage of desorbed CO₂, to separate the CO₂ gas that is to be stored from the heating gas that is emitted with the CO₂ from the extraction reactor.

Another advantage of using the extracted gas/gas to be extracted, that is, for example CO₂, as heating gas is that the at least one heating gas store can be fed with the heating gas, for example CO₂, from the at least one extracted gas store.

In order for the gas mixture air to flow through efficiently, there may be provided at least one gas mixture conveying assembly for conveying air through the at least one extraction reactor in the adsorption mode.

In order to be able to remove, firstly, the gas mixture air and, secondly, the desorbed extracted gas CO₂ or/and heating gas from the at least one extraction reactor, there may be provided at least one extraction reactor emptying pump for pumping air out of the at least one extraction reactor, preferably to the surroundings, in a gas mixture pump-out mode or/and for pumping CO₂ out of the at least one extraction reactor into the extracted gas storage tank in the desorption mode.

In order to be able to efficiently utilize the energy used for increasing temperature in the heating mode, it is proposed that there be provided at least one extracted gas heat-exchange assembly for transferring heat conveyed in the CO₂ conducted to the at least one extracted gas store in the desorption mode to a heat-absorbing medium.

Particularly efficient extraction of CO₂ can be ensured by providing a plurality of extraction reactors.

In order then to also be able to achieve virtually continuous extraction in the operation including the three operating phases adsorption mode, heating mode and desorption mode, it is proposed that, when a portion of the extraction reactors is to be operated in the desorption mode, a portion of the extraction reactors be operable in the adsorption mode or/and a portion of the extraction reactors be operable in the heating mode. This means that at least two of these operating phases can run at the same time in the various extraction reactors.

According to various embodiments, the heating assembly is configured to supply the heating gas only to the portion of the extraction reactors operated in the heating mode.

At the same time, for efficient heat recirculation, the heat-absorbing medium may include the heating gas supplied to the portion of the extraction reactors operated in the heating mode.

According to a further aspect of the present disclosure, the object stated at the outset is achieved by a method for extracting CO₂ from air, preferably via an apparatus according to the disclosure, including the measures of:
a) in an adsorption mode, conveying air through at least one extraction reactor and adsorbing CO₂ on an adsorption surface of the at least one extraction reactor,
b) in a heating mode following the adsorption mode, heating the at least one extraction reactor at least in the region of its adsorption surface to a temperature above an extracted gas desorption temperature,
c) in a desorption mode following the heating mode, conducting CO₂ desorbed from the at least one extraction reactor to at least one extracted gas store.

In order to ensure that, in the desorption mode, only desorbed CO₂ is conducted to the at least one extracted gas store, it is proposed that, after the end of the adsorption mode and before the start of the heating mode, air present in the at least one extraction reactor be pumped out as residual gas atmosphere in a gas mixture pump-out mode.

A virtually continuous CO₂ extraction process may be achieved by using a plurality of extraction reactors, in which case, when a portion of the extraction reactors is operated in the desorption mode, a portion of the extraction reactors is operated in the adsorption mode or/and a portion of the extraction reactors is operated in the heating mode.

In the method according to the disclosure, at least a portion of the energy used for heating at least one extraction reactor in the heating mode may be recovered by withdrawing heat from the CO₂ conducted from the portion of the extraction reactors operated in the desorption mode to the at least one extracted gas store for heating of the portion of the extraction reactors operated in the heating mode.

### BRIEF DESCRIPTION OF DRAWINGS

The invention will now be described with reference to the drawings wherein:

FIG. 1 shows a schematic illustration of an apparatus for extracting CO₂ from air;

FIG. 2 shows a schematic sectional illustration of an extraction reactor of the apparatus of FIG. 1;

FIG. 3 shows a cross-sectional view of a substrate coated with an adsorption coating;

FIG. 4 shows a cross-sectional view of an extraction unit having a plurality of substrates coated with an adsorption coating;

FIG. 5 shows a cross-sectional view of an extraction unit of an alternative embodiment, the view corresponding to FIG. 4; and,

FIG. 6 shows a schematic illustration of an alternative embodiment of an apparatus for extracting CO₂ from air, the illustration corresponding to FIG. 1.

### DETAILED DESCRIPTION

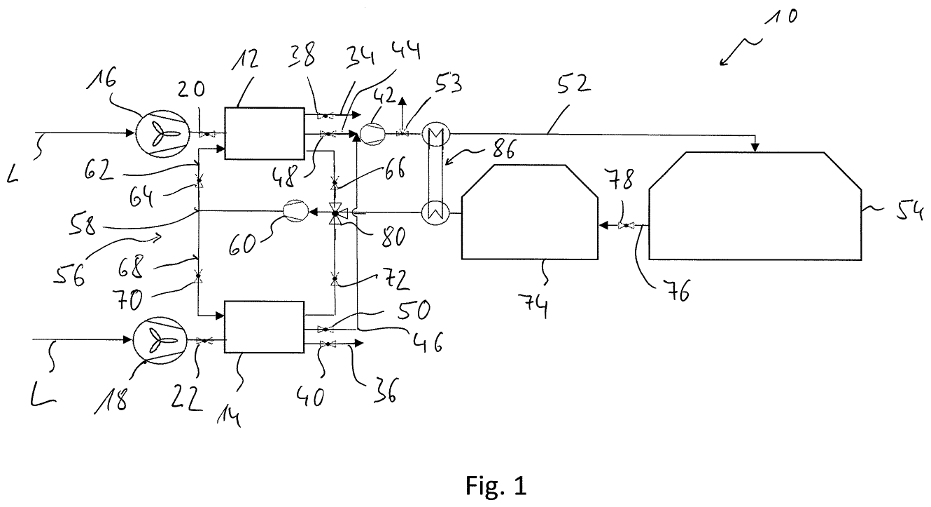

Referring to FIGS. 1 to 5, a first embodiment of an apparatus 10 for extracting CO₂ will be described in the following. The DAC (direct air capture) apparatus 10 includes, as essential component, two extraction reactors 12, 14 which can be supplied with air L by way of a respectively associated gas mixture conveying assembly 16, 18 in the form of, for example, a fan or compressor or the like. Respectively disposed in the flow path from a respective gas mixture conveying assembly 16, 18 to the associated extraction reactor 12, 14 is a shutoff valve 20, 22 via which the air flow path into the respective extraction reactor 12, 14 can be unblocked or blocked.

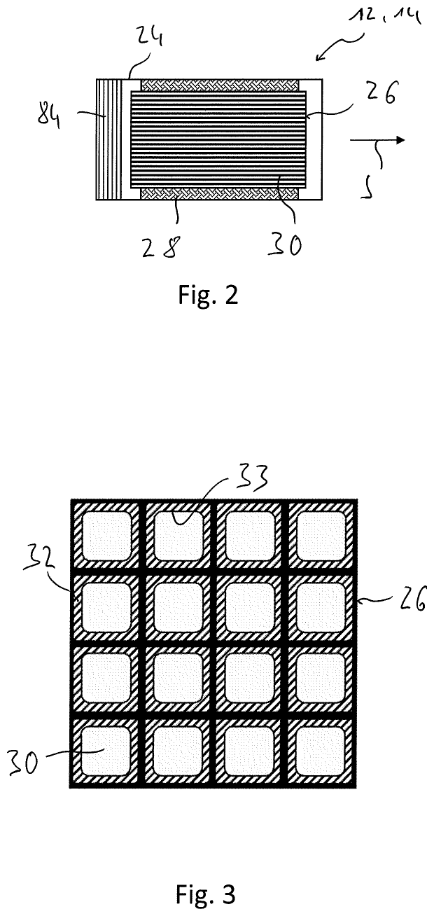

FIG. 2 shows a schematic illustration of an embodiment of such an extraction reactor 12, 14. The embodiment of FIG. 2 includes a, for example, tubular housing 24 wherein a substrate 26 is supported, for example, by fibrous support material 28. The substrate 26 has a multiplicity of flow channels or cells 30 which extend essentially in an air flow direction S and through which the air L conveyed by the respective gas mixture conveying assembly 16, 18 can flow in the air flow direction S. Such substrates made of, for example, ceramic or metallic material, for example SiC (silicon carbide) or cordierite, are known, for example, from the structure of exhaust gas cleaning systems, that is, particulate filters or catalytic converters, in exhaust gas systems of internal combustion engines. In an alternative embodiment, the substrate 26 may be made of metallic material or ceramic material, for example in the form of a metallic honeycomb structure or a honeycomb structure made of ceramic material or in the form of an open-cell metallic foam or ceramic foam, that provides a multiplicity of flow-through flow channels.

As illustrated by the example cross section of the substrate 26 illustrated in FIG. 3, the cells 30 formed in the substrate 26 provide a comparatively large surface at which the air flowing through the substrate 26 can come into contact with the substrate 26 or an adsorption coating 32 provided thereon. The adsorption coating 32 provides an adsorption surface 33 which comes into contact with the air L. For example, such a substrate may have a cell density of 40 cpsi (cells per square inch) to 750 cpsi and may have, in the case of a circular outer peripheral contour for example, a diameter of up to 13 inches, that is, 32 cm to 33 cm. In the case of an embodiment with a, for example, square cross-sectional geometry, the substrate may have an edge length of, for example, 10 cm to 30 cm.

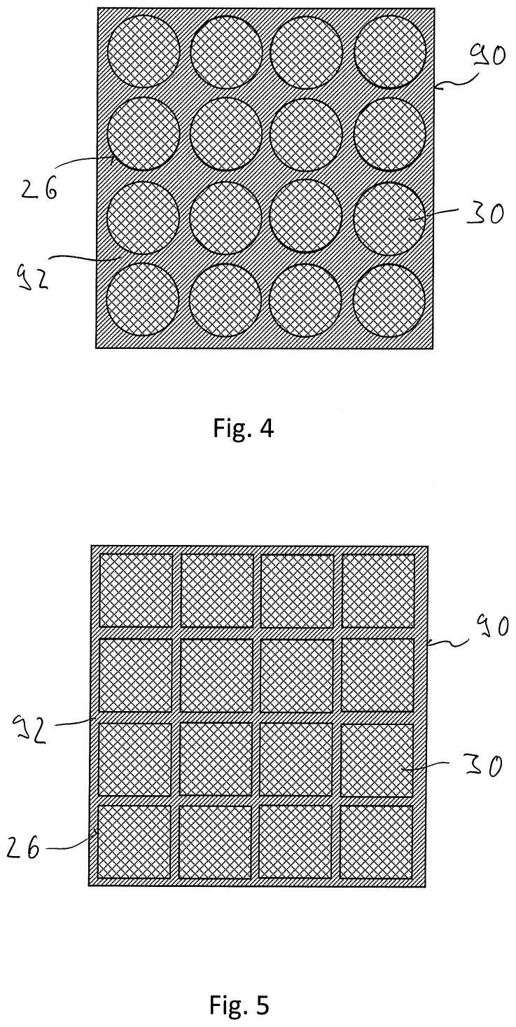

FIGS. 4 and 5 show different embodiments of extraction units 90, each of which includes a plurality of the substrates 26 coated with an adsorption coating 32. Each extraction unit 90 includes a support structure 92 in which a multiplicity of the substrates 26 is supported. The support structure 92 made of, for example, plastics material or metallic material may be a structure through which gas is not able to flow, such that the entire gas mixture introduced into a respective extraction reactor 12, 14 flows through the cells 30 or the flow channels of the substrates 26.

In the embodiment of the extraction unit 90 shown in FIG. 4, the substrates 26 have a circular cross section and are arranged in a square pattern, yielding mutually parallel rows and columns of substrates 26 which are substantially non-staggered with respect to one another. In the case of a structure contributing to a relatively high density of the substrates 26, the substrates 26 of adjacent columns or rows may be staggered with respect to one another, producing an arrangement in the manner of a highly dense sphere packing.

FIG. 5 shows an arrangement of substrates 26 having a square cross section in the extraction unit 90. Here too, the substrates 26 are arranged relative to one another in a square pattern, yielding mutually parallel columns and rows of substrates 26 substantially non-staggered with respect to one another.

In principle, the substrates 26 may also have other cross-sectional geometries, for example a hexagonal or octagonal cross-sectional geometry, in order to allow a densest possible arrangement thereof in such an extraction unit 90.

The use of the extraction units 90 in the extraction reactors 12, 14 makes it possible, in the case of such DAC apparatuses of generally stationary operation, to conduct large volume flows of the gas mixture, that is, for example air, through the extraction reactors 12, 14 and thus also to provide correspondingly large surfaces for treatment of the gas mixture or for extraction of the gas to be extracted, that is, for example CO₂.

The adsorption coating 32 may made of, for example, zeolite or an organometallic material or organometallic lattice structure, for example MOF CALF-20, that is, a material which has high selectivity with respect to the CO₂ gas to be adsorbed.

In an adsorption mode, the air L, that is, ambient air taken from the earth's atmosphere for example, is conducted via the gas mixture conveying assemblies 16, 18 into the respectively associated extraction reactor 12, 14 while the shutoff valve 20, 22 is respectively opened. As it flows through the cells 30 of the substrate 26, CO₂ present in the air L is adsorbed on the adsorption surface 33 provided by the adsorption coating 32, such that air L which has been depleted of CO₂ and ideally no longer contains CO₂ can be discharged back to the surroundings via a respective gas mixture discharge line 34, 36.

Associated with each gas mixture discharge line 34, 36 is a shutoff valve 38, 40 which allows the discharge of air L to the surroundings in the adsorption mode, but can fundamentally completely block the flow of air through the extraction reactor 12, 14 in conjunction with the shutoff valve 20, 22 respectively upstream of the extraction reactor 12, 14.

The apparatus 10 further includes an extraction reactor emptying pump 42 which is connected via a respective emptying line 44, 46 to the extraction reactors 12, 14. Disposed in each emptying line 44, 46 is a further shutoff valve 48, 50 via which the respectively associated emptying line 44, 46 can be unblocked, in order for air L still present in the respective extractor reactor 12, 14 to be removed by suction while the shutoff valve 20, 22 is respectively closed, or blocked. Following an adsorption mode and with the shutoff valves 20, 22, 38, 40 in the shutoff position and the shutoff valves 48, 50 in the release position, air L which is still present in the extraction reactor 12, 14 can be pumped out in a gas mixture pump-out mode, such that a negative pressure is generated in the extraction reactors 12, 14. The air L pumped out of the extraction reactors 12, 14 in the gas mixture pump-out mode can be discharged to the surroundings via a discharge line 52 and a directional valve 53 disposed therein.

The discharge line 52 leads to an extracted gas store 54 in which, in a desorption mode that will be described in the following, CO₂ pumped out of the extraction reactors 12, 14 via the extraction reactor emptying pump 42 can be stored under a pressure of, for example, up to 50 bar and at ambient temperature. In the desorption mode, that is, while conveying CO₂ from the extraction reactors 12, 14 to the extracted gas store 54, the position of the directional valve 53 is such that the flow path from the extraction reactor emptying pump 42 to the extracted gas store 54 is unblocked and no CO₂ is emitted to the surroundings.

The apparatus 10 further includes a heating assembly indicated generally by 56. The heating assembly 56, in a heating mode, heats the extraction reactors 12, 14, or the substrate 26 with the adsorption coating 32 respectively present therein, to a temperature above a desorption temperature of the CO₂. For example, heating may be carried out to a temperature of higher than 50° C., preferably in the range from 100° C. to 150° C., in order to achieve substantially complete and rapid desorption of CO₂.

The heating assembly 56 includes a heating gas circuit 58 in which a heating gas is conveyed through the cells 30 of the substrates 26 present in the extraction reactors 12, 14, conveyed via a heating gas conveying assembly 60 in the form of a fan, compressor or the like. The heating gas circuit 58 includes, in association with the extraction reactor 12, a first partial circuit 62 in which a shutoff valve 64, 66 is respectively provided upstream and downstream of the extraction reactor 12 and upstream and downstream of the heating gas conveying assembly 60. Furthermore, the heating gas circuit 58 includes, in association with the extraction reactor 14, a second partial circuit 68 in which a shutoff valve 70, 72 is respectively provided upstream and downstream of the extraction reactor 14 and upstream and downstream of the heating gas conveying assembly 60.

When the shutoff valves 64, 66 are in the release position and the shutoff valves 70, 72 are in the shutoff position, the heating gas conveyed via the heating gas conveying assembly 60 flows into the first partial circuit 62 and thus through the extraction reactor 12. When the shutoff valves 70, 72 are in the release position and the shutoff valves 64, 66 are in the shutoff position, the heating gas conveyed via the heating gas conveying assembly 60 flows through the extraction reactor 14.

The heating assembly 56 further includes a heating gas store 74. In the apparatus shown in FIG. 1, the heating gas used is CO₂, and the heating gas store 74 can therefore advantageously be fed from the extracted gas store 54 via a feed line 76. To refeed CO₂ into the heating gas store 74, a shutoff valve 78 provided in the feed line 76 can be brought to its release position, so that pressurized CO₂ flows out of the extracted gas store 54 into the heating gas store 74. To stop CO₂ from being refed into the heating gas store 74, the shutoff valve 78 is brought to its shutoff position.

For introduction of the heating gas, that is, CO₂, into the heating gas circuit 58, a directional valve 80 is provided upstream of the heating gas conveying assembly 60. Depending on which of the extraction reactors 12 and 14 the heating gas is to be conducted through, the valve can be positioned such that either heating gas flowing out of the extraction reactor 12 can flow back to the heating gas conveying assembly 60 via the shutoff valve 66 in its release position or heating gas flowing out of the extraction reactor 14 can flow back to the heating gas conveying assembly 60 via the shutoff valve 72 in its release position. In addition, the directional valve 80 can establish a flow connection between the heating gas store 74 and the heating gas conveying assembly 60, such that the heating gas discharged from a respective extraction reactor 12, 14 can also be mixed with heating gas discharged from the heating gas store 74, that is, the latter can be introduced into the heating gas circuit 58. Especially at the start of the heating mode, complete filling of the heating gas circuit 58, or the partial circuit 62, 68 that is currently active, can be accomplished by positioning the directional valve 80 such that heating gas, that is, CO₂, is introduced from the heating gas store 74 into the heating gas circuit 58. The direction valve 80 can fundamentally also stop the connection between the heating gas store 74 and the heating gas circuit 58, such that the heating gas circuit 58 or the two partial circuits 62, 68 thereof form closed circuits.

The operation of the apparatus 10 for extraction of CO₂ from air with the different operating modes or operating phases that have already be discussed in part will be described in the following.

With the apparatus 10, the two extraction reactors 12, 14 can each be operated alternately in the adsorption mode or in the heating mode or in the desorption mode, such that substantially continuous extraction of CO₂ from the air L can be carried out over time. During operation of the extraction reactor 12 in the adsorption mode, its shutoff valves 20, 38 are in their release position, whereas the shutoff valves 64, 66 of the first partial circuit 62 that are associated with the extraction reactor 12 are in their shutoff position. In the adsorption mode of the extraction reactor 12, the air introduced into it via the gas mixture conveying assembly 16 flows through the cells 30 of the substrate 26 of the extraction reactor 12 and, at the same time, CO₂ present in the air L is adsorbed on the surface of the CO₂ adsorption material 32.

While the extraction reactor 12 is being operated in the adsorption mode, the extraction reactor 14 is being operated in the heating mode or in the desorption mode. To this end, what is first carried out, in the heating mode, for the extraction reactor 14 previously operated in the adsorption mode is to conduct the heating gas through the cells 30 of the substrate 26 of the extraction reactor 14 via the second partial circuit 68 with the shutoff valves 70, 72 in their release position. Since the heating gas used in this state is pure CO₂, further adsorption of CO₂ on the CO₂ adsorption material 32 of the extraction reactor 14 can occur. To compensate for this CO₂ adsorption, CO₂ can be refed into the heating gas circuit 58 from the heating gas store 74 by appropriate control of the directional valve 80.

In order to actually achieve heating of the extraction reactor 14, or the substrate 26 thereof coated with the CO₂ adsorption material 32, via the heating gas circulating in the heating gas circuit 58, the heating assembly 56 includes a heating gas heating device 82 which is associated with each of the two extraction reactors 12, 14 and which can be seen in FIG. 2. In the embodiment shown in FIG. 2, the heating gas heating device 82 includes an electrically energizable heating gas heater 84. It may have a heating conductor which has, for example, spiral or meandering winding and which is heated by application of a voltage. As it flows into a respective extraction reactor 12 or 14, the heating gas conveyed via the heating gas conveying assembly 60 flows through the heating gas heater 84 disposed immediately in front of, that is, upstream of, the substrate 26, absorbs heat in the process, and transfers the heat to the substrate 26. Since the heating gas heater 84 is disposed immediately in front of the substrate 26, this ensures that the temperature of the heating gas flowing through the cells 30 of the substrate 26 is substantially the same as that of the heating gas leaving the heating gas heater 84, thus allowing efficient heating of the substrate 26 or the adsorption coating 32.

When the substrate 26 or the adsorption coating 32 has reached a temperature ensuring the desorption of CO₂, the conveying of heating gas, that is, CO₂, through the extraction reactor 14 initially operated in the heating mode is stopped. The shutoff valves 70, 72 are brought into their shutoff position, and the directional valve 80 is brought into its decoupling position with respect to the heating gas store 74. Thereafter, for the desorption mode of the extraction reactor 14, the shutoff valve 50 provided in the emptying line 46 is then brought into its release position, and operation of the extraction reactor emptying pump 42 is started, such that heating gas still present in the extraction reactor 14 and desorbed CO₂ is conveyed into the extracted gas store 54 via the emptying line 46 and the discharge line 52. In this state, the shutoff valves 22, 40, 70, 72 associated with the extraction reactor 14 are in their shutoff position, such that neither air L nor heating gas can flow into the extraction reactor 14.

Even before the start of the desorption mode for the extraction reactor 14, what can be carried out for the extraction reactor 12 initially operated in the adsorption mode is to end the adsorption mode and to change it into the gas mixture pump-out mode, in which the air still present in the extraction reactor 12 is pumped out via the extraction reactor emptying pump 42 with the shutoff valves 20, 38, 64, 66 in their shutoff position and is conveyed to the surroundings via the directional valve 53. Since the extraction reactor emptying pump 42 is associated with both extraction reactors 12, 14 and it is used both for pumping out air and for pumping out desorbed CO₂, it is advantageous and necessary to carry out the gas mixture pump-out mode to pump air L out of one of the two CO₂ extraction reactors 12, 14 before CO₂ desorbed in the desorption mode in the other extraction reactor 12, 14 is conveyed in the direction of the extracted gas store 54 via the extraction reactor emptying pump 42. In order to be able to carry out these operating phases on the two extraction reactors 12, 14 with a temporal overlap as well, an independently operable extraction reactor emptying pump may, for example, be associated with each of the two extraction reactors 12, 14.

When the gas mixture pump-out mode has ended for the CO₂ extraction reactor 12 at or after the end of the adsorption mode, its shutoff valve 48 is brought into the shutoff position, and the desorption mode of the extraction reactor 14 can be started with the opening of the shutoff valve 50. Since the substrate 26 of the extraction reactor 14 has been brought to a sufficiently high temperature in the preceding heating mode and also has a comparatively large heat storage capacity, this can ensure that substantially the entire CO₂ adsorbed on the adsorption material of the extraction reactor 14 is desorbed and discharged from the extraction reactor 14 in the desorption mode.

While the extraction reactor 14 is being operated in the desorption mode, the heating mode can be started or carried out for the extraction reactor 12 by opening the shutoff valves 64, 66 and starting operation of the heating gas conveying assembly 60 in order to bring the extraction reactor 12 to a sufficiently high temperature for the subsequent desorption of the CO₂ adsorbed therein, in the same way as also described above in relation to the extraction reactor 14. During the heating mode of the extraction reactor 12, the desorption mode of the extraction reactor 14 can be ended with the closure of the shutoff valve 50 and also the deactivation of the extraction reactor emptying pump 42. For the extraction reactor 14, the adsorption mode can then be restarted by opening the shutoff valves 22, 40 and starting operation of the gas mixture conveying assembly 18 and thus introducing a gas mixture containing a gas to be extracted into the extraction reactor 14.

In order to be able to operate as efficiently as possible with this alternating operation of the two extraction reactors 12, 14, the heating assembly 58 includes an extracted gas heat exchanger indicated generally by 86. The heat exchanger is configured to transfer heat from the CO₂ extracted gas conveyed into the extracted gas store 54 via the discharge line 52 to the CO₂ introduced into the heating gas circuit 58 from the heating gas store 74 as heating gas. As a result, the CO₂ leaving the respective extraction reactor 12, 14 at a comparatively high temperature is cooled, which facilitates its storage in the extracted gas store 54, and the heat released in the process can be transferred to, and thus already preheat, the CO₂ heating gas introduced into the heating gas circuit 58.

Therefore, it is particularly advantageous, in the alternating operation of the two extraction reactors 12, 14, to operate one of the two extraction reactors 12, 14 in the heating mode, while the other of the two extraction reactors 12, 14 is operated in the desorption mode. It is only in these two operating modes that, firstly, the CO₂ desorption gas is discharged from one of the two extraction reactors at a comparatively high temperature and, secondly, CO₂ as heating gas is discharged from the heating gas store 74 approximately at ambient temperature and conducted toward the heating gas circuit 58.

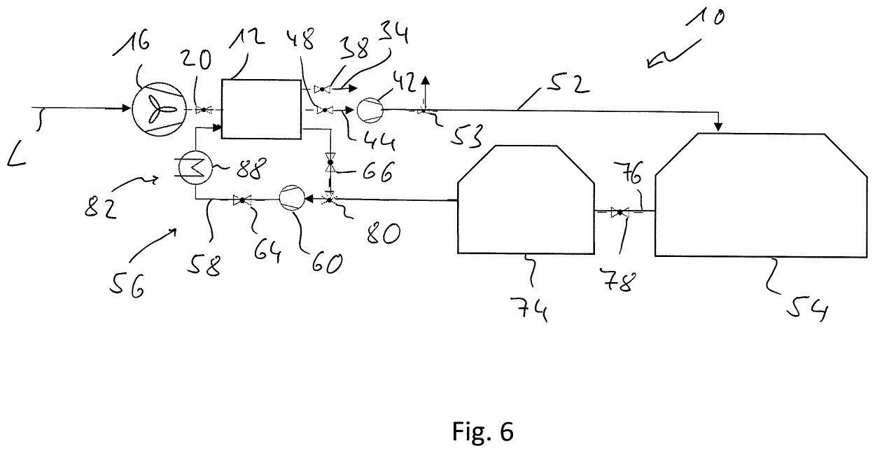

An alternative embodiment of the apparatus 10 for extracting CO₂ from air is shown in FIG. 6. The apparatus 10 may have the same fundamental configuration as the apparatus 10 described above in relation to FIG. 1. By way of example, the apparatus 10 of FIG. 6 may alternatively include only a single extraction reactor 12 with the associated areas of the system.

In the embodiment of the apparatus 10 shown in FIG. 6, the heating assembly 56 includes a heating gas heat exchanger 88 as heating gas heating device 82. The heat exchanger is integrated into the heating gas circuit 58 and transfers the heat conveyed in a heating medium to the heating gas, that is, CO₂ for example, flowing or circulating in the heating gas circuit 58. The heating medium may be a liquid or gaseous medium which absorbs heat at an external heat source, for example including by solar thermal energy or the like, and transfers it to the heating gas in the heating gas heat exchanger 88.

It is self-evident that such an embodiment of the heating gas heating device 82 may also be provided for the apparatus 10 which is shown in FIG. 1 and has multiple extraction reactors 12, 14 operating in parallel or alternately.

The different operating modes adsorption mode, desorption mode, heating mode/pump-out mode may each be carried out over fixed periods associated therewith, preferably in coordination with one another. Alternatively or additionally, by providing suitable sensors, it is possible to detect the presence of defined states, for example the attainment of a sufficiently high temperature for desorption or of a specific gas concentration or the like, and, when such a state is present, to then change from one operating phase into the next operating phase.

It should be noted that, in an embodiment of the apparatus 10 with multiple extraction reactors, there may be provided more than two such reactors, which may then be operated alternately in the different operating modes. For example, a first portion of the extraction reactors may be operated in the adsorption mode, while a second portion is being operated in the heating mode and a third portion is being operated in the desorption mode. These three operating phases to be carried out successively in each of the extraction reactors may then be interchanged among the individual extraction reactors, such that there is always at least one extraction reactor operating in the desorption mode and thus also providing, via the CO₂ conveyed toward the extracted gas store, a source of heat for the heating of the heating gas for at least one extraction reactor simultaneously operated in the heating mode.

In an embodiment of the device 10 with multiple extraction reactors, they may in principle also be operated synchronously, that is, in the same operating mode at any one time, thereby making it possible for the apparatus to have a simple configuration through a reduction in the number of necessary pumps, fans, shutoff valves and the like.

It is understood that the foregoing description is that of the preferred embodiments of the invention and that various changes and modifications may be made thereto without departing from the spirit and scope of the invention as defined in the appended claims.

1. An apparatus for extracting CO₂ from air, comprising:
at least one extraction reactor being through flowable by CO₂-containing air in an adsorption mode and having an adsorption surface;
a heating assembly for heating said at least one extraction reactor at least in a region of said adsorption surface to a temperature above an extracted gas desorption temperature in a heating mode; and,
at least one extracted gas store for storing CO₂ desorbed from said at least one extraction reactor in a desorption mode.

2. The apparatus of claim 1, wherein said at least one extraction reactor comprises at least one substrate having a multiplicity of flow-through cells or flow channels of a porous structure; and, said substrate is coated with an adsorption coating providing said adsorption surface.

3. The apparatus of claim 2, wherein said at least one extraction reactor comprises an extraction unit having a plurality of parallel substrates wherethrough air can flow and said plurality of parallel substrates are coated with an adsorption coating.

4. The apparatus of claim 2, wherein said at least one substrate is made of one of the following: SiC; or, cordierite; or, a metallic material; or, a metal foam; or, metallic honeycomb structure; or a ceramic material; and, a ceramic foam or ceramic honeycomb structure.

5. The apparatus of claim 2, wherein said adsorption coating is made of: zeolite; or, an organometallic material.

6. The apparatus of claim 1, wherein said heating assembly comprises: a heating gas circuit with a heating gas conveying assembly for conveying heating gas through said at least one extraction reactor; and, a heating gas heating device for heating the heating gas to a temperature above the extracted gas desorption temperature.

7. The apparatus of claim 6, wherein said heating gas heating device comprises at least one of:
i) at least one electrically energizable heating gas heater; and,
ii) at least one heating gas heat exchanger wherethrough a heat transfer medium can flow.

8. The apparatus of claim 6, wherein said heating assembly comprises at least one heating gas store.

9. The apparatus of claim 6, wherein said heating gas is CO₂.

10. The apparatus of claim 8, wherein said at least one heating gas store is feedable with CO₂ from said at least one extracted gas store.

11. The apparatus of claim 1, further comprising at least one gas mixture conveying assembly for conveying air through said at least one extraction reactor in the adsorption mode.

12. The apparatus of claim 1, further comprising at least one of:
i) at least one extraction reactor emptying pump for pumping air out of said at least one extraction reactor in a gas mixture pump-out mode; and,
ii) at least one extraction reactor emptying pump for pumping CO₂ out of the at least one extraction reactor into the extracted gas store in the desorption mode.

13. The apparatus of claim 6, further comprising: at least one extracted gas heat-exchange assembly configured to transfer heat conveyed in the CO₂ conducted to said at least one extracted gas store in the desorption mode to a heat-absorbing medium.

14. The apparatus of claim 13, further comprising a plurality of extraction reactors.

15. The apparatus of claim 14, wherein at least one of the following applies:
i) when a first portion of said plurality of extraction reactors is to be operated in the desorption mode, a second portion of said plurality of extraction reactors is operable in the adsorption mode; and,
ii) a second portion of said plurality of extraction reactors is operable in the heating mode.

16. The apparatus of claim 15, wherein said heating assembly is configured to supply the heating gas only to the second portion of the plurality of extraction reactors operated in the heating mode.

17. The apparatus of claim 15, wherein the heat-absorbing medium comprises the heating gas supplied to the second portion of the plurality of extraction reactors operated in the heating mode.

18. The apparatus of claim 1, further comprising at least one extraction reactor emptying pump for pumping air out of the at least one extraction reactor to the surroundings.

19. A method for extracting CO₂ from air via an apparatus including at least one extraction reactor being through flowable by CO₂-containing air in an adsorption mode and having an adsorption surface; a heating assembly for heating said at least one extraction reactor at least in a region of said adsorption surface to a temperature above an extracted gas desorption temperature in a heating mode; and, at least one extracted gas store for storing CO₂ desorbed from said at least one extraction reactor in a desorption mode; the method comprising the steps of:
a) in an adsorption mode, conveying air through the at least one extraction reactor and adsorbing CO₂ on an adsorption surface of the at least one extraction reactor;
b) in a heating mode following the adsorption mode, heating the at least one extraction reactor at least in the region of the adsorption surface thereof to a temperature above an extracted gas desorption temperature; and,
c) in a desorption mode following the heating mode, conducting CO₂ desorbed from the at least one extraction reactor to at least one extracted gas store.

20. The method of claim 19, wherein, after the end of the adsorption mode and before the start of the heating mode, air present in the at least one extraction reactor is pumped out in a gas mixture pump-out mode.

21. The method of claim 19, wherein a plurality of extraction reactors is used, and when a portion of the extraction reactors is operated in the desorption mode, at least one of the following applies:
i) a first portion of the extraction reactors is operated in the adsorption mode; and,
ii) a second portion of the extraction reactors is operated in the heating mode.

22. The method of 21, wherein heat is withdrawn from the CO₂ conducted from the portion of the extraction reactors operated in the desorption mode to the at least one extracted gas store for heating of the portion of the extraction reactors operated in the heating mode.
